(19) United States
(12) Patent Application Publication
(10) Pub. No.: US 2026/0111700 A1
(43) Pub. Date: Apr. 23, 2026

(54) ACCELERATOR PERFORMING PREFETCH OPERATION AND NEURAL NETWORK SYSTEM INCLUDING THE SAME

(71) Applicants: SK hynix Inc., Icheon-si (KR); INDUSTRY-ACADEMIC COOPERATION FOUNDATION YONSEI UNIVERSITY, Seoul (KR)

(72) Inventors: Seunghwan SUNG, Seoul (KR); Won Woo RO, Seoul (KR); Jungmin CHOI, Icheon-si (KR); Byungil KOH, Icheon-si (KR)

(21) Appl. No.: 19/027,805

(22) Filed: Jan. 17, 2025

(30) Foreign Application Priority Data
Oct. 18, 2024 (KR) 10-2024-0143047

(51) Int. Cl. G06N 3/042; G06N 3/045

(52) U.S. Cl. CPC G06N 3/042; G06N 3/045

(57) ABSTRACT

An accelerator includes a computation circuit configured to perform a neural network operation using a token included in input data and a first parameter set; a main memory; and a control circuit configured to request the first parameter set from an external device or the main memory, and to provide the first parameter set to the computation circuit, wherein the control circuit is configured to prefetch one or more parameter sets from a plurality of parameter sets based on neural network usage information including number of tokens processed by each of a plurality of neural networks.

### CROSS-REFERENCE TO RELATED APPLICATION

The present application claims priority under 35 U.S. C. § 119(a) to Korean Patent Application No. 10-2024-0143047, filed on Oct. 18, 2024, which is incorporated herein by reference in its entirety.

### BACKGROUND

### 1. Technical Field

Embodiments generally relate to an accelerator performing a prefetch operation and a neural network system including the accelerator.

### 2. Related Art

A neural network, such as a large language model, processes substantial amounts of data during inference and learning operations, thereby aggravating bottlenecks in memory devices.

In order to increase the size of the model, a parallel processing neural network, such as a Mixture of Experts (MoE) neural network, has been proposed; however, this network further aggravates the bottlenecks.

The MoE neural network includes multiple expert neural networks. Conventionally, inference and learning operations are performed by distributing and allocating these multiple expert neural networks across multiple accelerators within the larger neural network architecture.

FIG. 1 illustrates a conventional neural network system 1.

The conventional neural network system 1 includes multiple accelerators, and FIG. 1 shows that n accelerators 10₁ to 10ₙ are included in the neural network system 1, where n is an integer greater than 1.

An expert neural network and a gating layer are allocated to each of the n accelerators 10₁ to 10ₙ. Therefore, the n accelerators 10₁ to 10ₙ include n expert neural network 11₁ to 11ₙ, respectively, and n gating layers 12₁ to 12ₙ, respectively. At this time, all gating layers 12₁ to 12ₙ included in the n accelerators 10₁ to 10ₙ have the same structure.

In each of the n accelerators 10₁ to 10ₙ, one or more different types of neural network layers may additionally exist between the expert neural network and the gating layer.

A specific expert neural network is fixedly assigned to each accelerator.

Hereinafter, subscripts are omitted unless referring to a specific component.

For example, in FIG. 1, a set of expert neural network parameters associated with the expert neural network 11ₙ assigned to the n-th accelerator 10ₙ is indicated as FFNₙ.

Input data is provided to each accelerator 10. FIG. 1 shows an example in which the input data includes k tokens T1 to Tk, k being an integer greater than 1.

A token is a sub element that constitutes the input data. For example, if a sentence corresponds to the input data, a token may correspond to a word that constitutes the sentence.

In the conventional accelerator 10, the gating layer 12 selects the expert neural network 11 based on a token and outputs the corresponding data.

This results in all-to-all communication between the accelerators 10₁ to 10ₙ, which delays the inference and learning operations.

In addition, the amount of data processed by the expert neural network 11 may vary across the accelerators 10₁ to 10ₙ. If load imbalance arises among the multiple accelerators 10₁ to 10ₙ, it delays the operation of the entire neural network system 1, leading to reduced efficiency.

To address the load imbalance, one approach involves predefining the processing capacity of each accelerator and discarding any data exceeding the processing capacity. However, this method reduces the accuracy of the neural network model.

### SUMMARY

In accordance with an embodiment of the present disclosure, an accelerator may include a computation circuit configured to perform a neural network operation using a token included in input data and a first parameter set; a main memory; and a control circuit configured to request the first parameter set from an external device or the main memory, and to provide the first parameter set to the computation circuit, wherein the control circuit is configured to prefetch one or more parameter sets from a plurality of parameter sets based on neural network usage information including number of tokens processed by each of a plurality of neural networks.

In accordance with an embodiment of the present disclosure, a neural network system may include a plurality of accelerators; and a shared memory storing a plurality of parameter sets corresponding to a plurality of neural networks, respectively, wherein each of the plurality of accelerators includes: a computation circuit configured to perform a neural network operation using a token included in input data and a first parameter set; a main memory; and a control circuit configured to request the first parameter set from the shared memory or the main memory, and configured to provide the first parameter set, wherein the control circuit is configured to prefetch one or more parameter sets from the plurality of parameter sets based on neural network usage information including number of tokens processed by each of the plurality of neural networks.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a conventional neural network system.

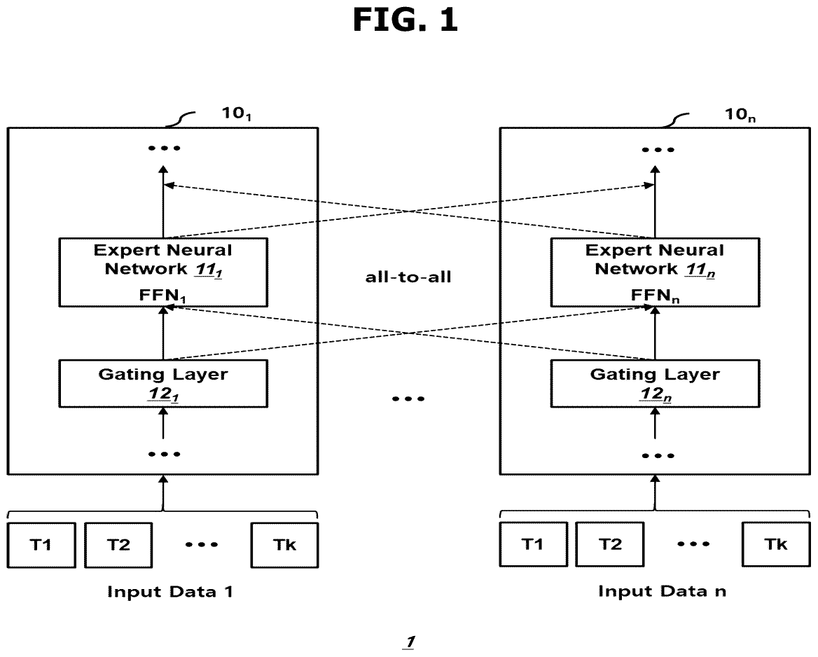

FIG. 2 illustrates a neural network system according to an embodiment of the present disclosure.

FIG. 3 illustrates an operation of a computation circuit according to an embodiment of the present disclosure.

FIG. 4 illustrates a main memory according to an embodiment of the present disclosure.

FIG. 5 is a table illustrating neural network usage information according to an embodiment of the present disclosure.

FIGS. 6 and 7 illustrate an operation of a control circuit according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

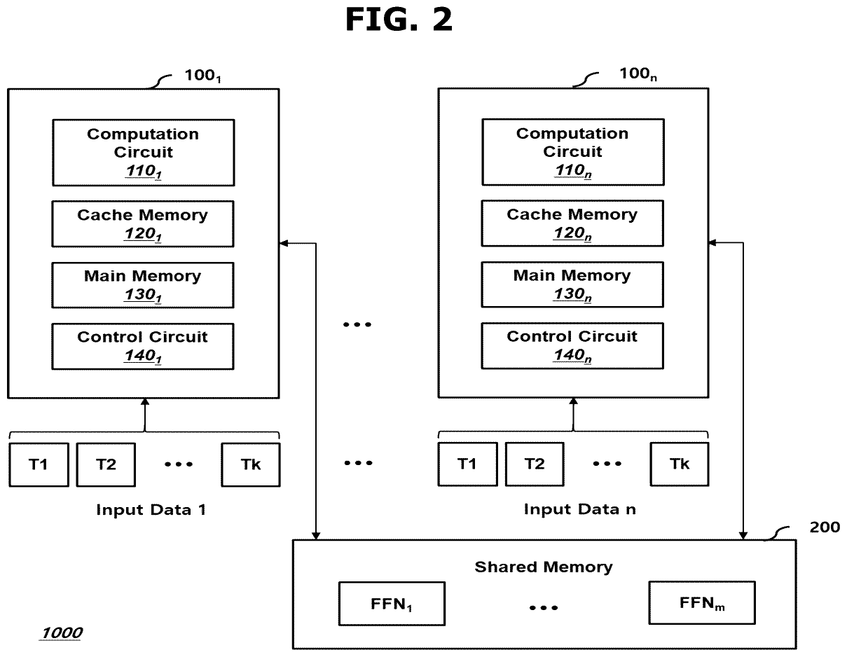

FIG. 2 illustrates a neural network system 1000 according to an embodiment of the present disclosure.

The neural network system 1000 includes a plurality of accelerators 100 and a shared memory 200.

The neural network system 1000 discloses an embodiment including n accelerators 100₁ to 100ₙ. In FIG. 2, a subscript indicates a corresponding accelerator. In this case, n is a natural number greater than or equal to 2.

Hereinafter, subscripts are omitted unless referring to a specific accelerator or a sub element thereof.

Hereinafter, an embodiment is disclosed where the neural network is an expert neural network, but a type of the neural network is not limited thereto.

Hereinafter, the neural network may be referred to as an expert neural network, and parameters configuring the neural network may be referred to as neural network parameters or expert neural network parameters.

An accelerator 100 includes a computation circuit 110, a cache memory 120, a main memory 130, and a control circuit 140.

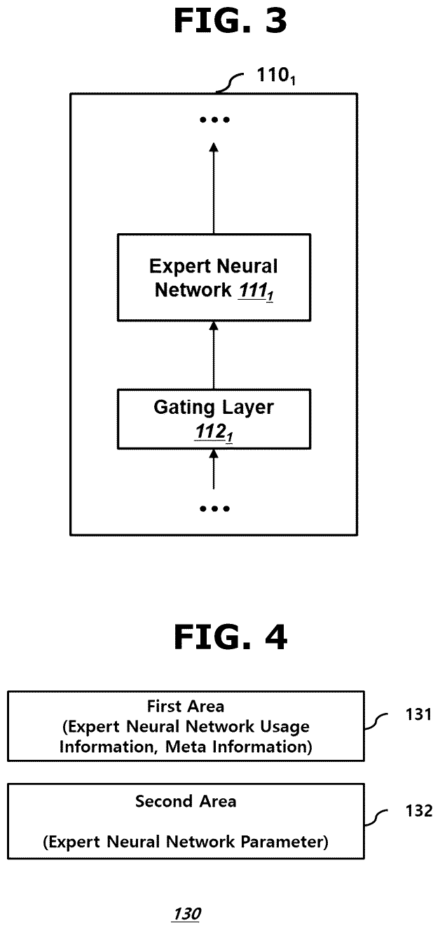

For example, FIG. 3 shows one of n computation circuits 110₁ to 110ₙ, e.g., the computation circuit 110₁ that includes an expert neural network 111₁ and a gating layer 112₁ allocated thereto. However, each of the other computation circuits 110₂ to 110ₙ may also have the same structure as the computation circuit 110₁.

In addition to the expert neural network 111 and the gating layer 112, a neural network layer that performs various neural network operations may be additionally allocated to the computation circuit 110.

The computation circuit 110, loaded with neural network layers such as the expert neural network 111 and the gating layer 112, may be implemented using software, hardware, or a combination thereof.

In this embodiment, unlike conventional approaches, a specific expert neural network is not fixedly allocated to the accelerator 100. Instead, an expert neural network corresponding to a token is selectively allocated to perform a neural network operation.

Accordingly, in this embodiment, all-to-all communication is not performed between the plurality of accelerators 100.

The gating layer 112 can identify a corresponding expert neural network corresponding to a token and provide identification information to the control circuit 140.

The computation circuit 110 performs a neural network operation using a set of expert neural network parameters FFN corresponding to a token included in input data.

The control circuit 140 responds by providing the set of expert neural network parameters FFN corresponding to a request with the identification information to the computation circuit 110. Hereinafter, a set of expert neural network parameters FFN may be referred to as a ‘parameter set.’

The shared memory 200 stores multiple parameter sets, e.g., multiple sets of expert neural network parameters FFN₁ to FFNₘ.

Since the parameter set generally requires a large amount of memory, the shared memory 200 may be implemented using a compute express link (CXL) memory or a large storage capacity.

The number of parameter sets and the number of accelerators are not necessarily equal.

Accordingly, in FIG. 2, the total number of parameter sets is denoted as m, with each parameter set distinguished by a subscript. In this case, m is a natural number greater than or equal to 2.

In each accelerator 100, the cache memory 120 is a space for temporarily storing a parameter set to be provided to the computation circuit 110.

The main memory 130 stores a parameter set prefetched from the shared memory 200. Hereinafter, a parameter set stored in the main memory 130 may be referred to as a prefetched parameter set.

Since a parameter set occupies a very large capacity, storing every parameter set in the main memory 130 is inefficient in terms of capacity, cost, and other factors.

In addition, if a parameter set is read anew each time a token is processed, the overall performance may degrade due to the limited performance of the shared memory 200.

Accordingly, in this embodiment, a parameter set expected to be used is prefetched and stored in the main memory 130. The prefetch operation is described in detail below.

If a required parameter set is not stored in the main memory 130, it is read from the shared memory 200, stored in the cache memory 120, and provided to the computation circuit 110.

If the required parameter set is stored in the main memory 130, the required parameter set is read from the main memory 130, stored in the cache memory 120, and provided to the computation circuit 110.

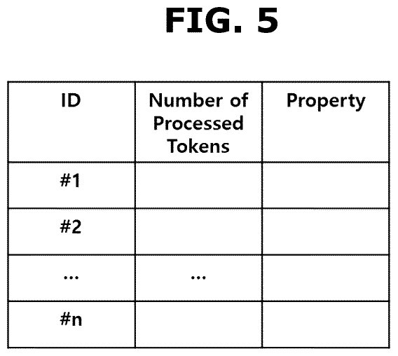

FIG. 4 illustrates the main memory 130 according to an embodiment of the present disclosure.

In this embodiment, the main memory 130 includes a first area 131 and a second area 132.

The first area 131 stores expert neural network usage information, and the second area 132 stores one or more parameter sets.

In this embodiment, the expert neural network usage information is used to manage the number of tokens processed by each expert neural network.

In this embodiment, the expert neural network usage information is stored in the first area 131 of the main memory 130. However, in other embodiments, the expert neural network usage information may be stored in a separate storage space within or outside the control circuit 140, rather than the main memory 130.

The second area 132 stores one or more parameter sets read during the prefetch operation.

The first area 131 may also store meta information, such as a type of a parameter set prefetched into the second area 132, the time of prefetch, and an address of the prefetched parameter set.

Accordingly, if the storage space of the second area 132 is insufficient, a newly prefetched parameter set can replace a previously prefetched parameter set, based on the meta information.

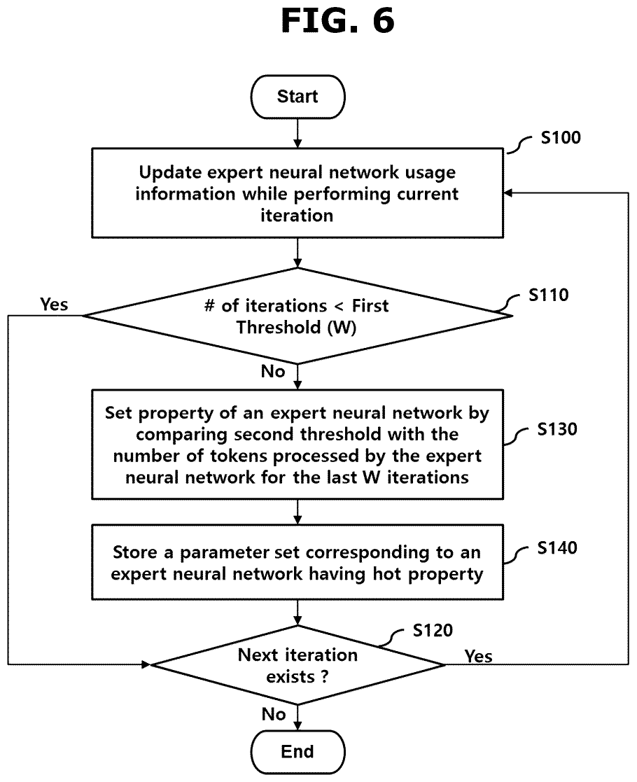

FIG. 5 is a table showing expert neural network usage information according to an embodiment of the present disclosure.

The expert neural network usage information includes the number of tokens processed by an expert neural network, associated with an identification ID that identifies a type of the expert neural network.

At this time, the number may correspond to the number of tokens processed over a predetermined number of input data or within a specific period of time.

The expert neural network usage information can further include properties of the expert neural network associated with the ID of the expert neural network.

For example, the properties of the expert neural network can be classified as HOT or COLD by comparing the number of tokens processed over a certain number of recent input data or within a certain period of time with a threshold.

In another embodiment, additional properties beyond HOT and COLD can be introduced by applying a plurality of thresholds.

The control circuit 140 manages the expert neural network usage information and can control the prefetch operation for a parameter set based on the expert neural network usage information. This will be disclosed in detail below.

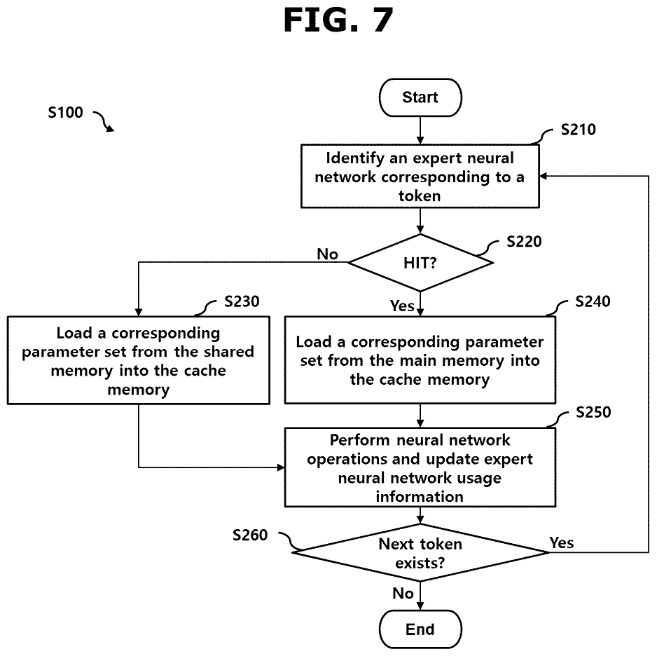

FIG. 6 is a flow chart showing an operation of the control circuit 140 according to an embodiment of the present disclosure.

The flow chart in FIG. illustrates the learning operation of the neural network. In general, the neural network learning operation includes multiple iterations.

In this embodiment, a prefetch operation is not performed during a predetermined number of initial iterations, but is instead performed after the predetermined number is reached. Whether or not to perform a prefetch operation at the beginning may vary depending on the embodiment.

When the learning operation starts, the expert neural network usage information is updated during the current iteration at step S100.

To update the expert neural network usage information, the number of tokens processed by each expert neural network can be accumulated and stored in the table shown in FIG. 5.

At this time, the number of tokens processed may be accumulated only for a certain number of recent input data or over a certain period of time. In this embodiment, numbers of tokens processed during the last W iterations are accumulated, where W is a natural number greater than 2.

The step S100 will be disclosed in detail with reference to FIG. 7.

After that, it is determined at step S110 whether the number of iterations is less than a first threshold. At this time, the number of iterations represents the number of past iterations including the current iteration.

Hereinafter, the first threshold can be represented as W.

If the number of iterations is less than the first threshold W, it is determined at step S120 whether a next iteration exists. If the next iteration is present, the process goes back to the step S100, and if not, the learning operation is terminated.

At step S110, if the number of iterations is greater than or equal to the first threshold W, the property for each type of expert neural network is set at step S130.

The property of the expert neural network are determined by comparing the number of tokens processed during the last W iterations with a second threshold.

For example, if the number of tokens processed by the expert neural network is greater than or equal to the second threshold, the property of the expert neural network is set to HOT, and if not, it is set to COLD.

Thereafter, a parameter set corresponding to the expert neural network with the HOT property is stored in the main memory 130 at step S140.

This step involves prefetching a parameter set for the next iteration. In this embodiment, the prefetched parameter set is stored in the second area 132 of the main memory 130.

After that, the process goes back to the step S120 and the above-described operations are repeated.

FIG. 7 is a flowchart specifically disclosing the step S100 of FIG. 6.

In this embodiment, multiple tokens are sequentially processed during an iteration. However, a person skilled in the art can easily modify this to a method of processing multiple tokens from the input data in parallel by referring to this disclosure.

First, an expert neural network corresponding to a token is identified at step S210.

As described above, identifying the expert neural network corresponding to the token can be done by referring to an operation result of the gating layer 112.

Thereafter, at step S220, it is determined whether a parameter set corresponding to the identified expert neural network exists in the main memory 130.

In this embodiment, meta information about a prefetched parameter set is stored in the first area 131, while the prefetched parameter set is stored in the second area 132. This setup allows for easy checking of the presence or absence of the corresponding parameter set using the meta information.

If the corresponding parameter set does not exist in the main memory 130, the corresponding parameter set is read from the shared memory 200 and loaded into the cache memory at step S230.

If the corresponding parameter set exists in the main memory 130, the parameter set is loaded from the main memory 130 into the cache memory 120 at step S240.

Thereafter, at step S250, the neural network operation is performed using the parameter set loaded into the cache memory 120 and the expert neural network usage information is updated.

As aforementioned, the number of tokens processed by each expert neural network is accumulated while updating the expert neural network usage information.

Thereafter, it is determined at step S260 whether the next token exists. If the next token exists, the process goes back to the step S210 and the above-described operations repeated, and if not, the operation is terminated.

As described above, in the conventional approaches, the mapping between accelerators and multiple expert neural networks was fixed, requiring all-to-all communication between the accelerators, which could lead to token processing imbalances for each accelerator.

However, in this embodiment, since a parameter set is loaded variably based on a token, different accelerators can use the same parameter set at a specific time.

As aforementioned, the flowchart in FIG. 6 was created based on the learning operation of the neural network. However, a person skilled in the art can easily adapt it for the inference operation using the neural network referring to this disclosure.

For example, during an initial period when the number of inference operations is less than the first threshold, the prefetch operation is not performed, and the number of tokens processed by each expert neural network is accumulated. After this initial period, during subsequent inference operations, the prefetch operation can be performed based on the number of tokens processed during the inference operation.

Although various embodiments have been illustrated and described, various changes and modifications may be made to the described embodiments without departing from the spirit and scope of the invention as defined by the following claims.

What is claimed is:

1. An accelerator, comprising:
a computation circuit configured to perform a neural network operation using a token included in input data and a first parameter set;
a main memory; and
a control circuit configured to request the first parameter set from an external device or the main memory, and to provide the first parameter set to the computation circuit,
wherein the control circuit is configured to prefetch one or more parameter sets from a plurality of parameter sets based on neural network usage information including number of tokens processed by each of a plurality of neural networks.

2. The accelerator of claim 1, further including a cache memory temporarily storing the first parameter set to be provided to the computation circuit,
wherein the control circuit stores the first parameter set in the cache memory.

3. The accelerator of claim 1, wherein the main memory includes a first area for storing the neural network usage information and a second area storing the one or more parameter sets prefetched by the control circuit.

4. The accelerator of claim 1, wherein, when the accelerator performs a learning operation by performing a plurality of iterations,
the control circuit estimates a second parameter set to be used for a next iteration based on the number of tokens processed using the plurality of parameter sets during a predetermined number of recent iterations, requests the second parameter set from the external device, and stores the second parameter set in the main memory.

5. The accelerator of claim 1, wherein, when the accelerator performs an inference operation,
the control circuit estimates a second parameter set to be used for a next inference operation based on the number of tokens processed using the plurality of parameter sets during a predetermined number of recent inference operations, requests the second parameter set from the external device, and stores the second parameter set in the main memory.

6. A neural network system, comprising:
a plurality of accelerators; and
a shared memory storing a plurality of parameter sets corresponding to a plurality of neural networks, respectively,
wherein each of the plurality of accelerators includes:
a computation circuit configured to perform a neural network operation using a token included in input data and a first parameter set;
a main memory; and
a control circuit configured to request the first parameter set from the shared memory or the main memory, and to provide the first parameter set to the computation circuit,
wherein the control circuit is configured to prefetch one or more parameter sets from the plurality of parameter sets based on neural network usage information including number of tokens processed by each of the plurality of neural networks.

7. The neural network system of claim 6, wherein each of the plurality of accelerators further includes a cache memory temporarily storing the first parameter set to be provided to the computation circuit,
wherein the control circuit stores the first parameter set in the cache memory.

8. The neural network system of claim 6, wherein the main memory includes a first area for storing the neural network usage information and a second area storing the one or more parameter sets prefetched by the control circuit.

9. The neural network system of claim 6, wherein, when the accelerator performs a learning operation by performing a plurality of iterations,
the control circuit estimates a second parameter set to be used for a next iteration based on the number of tokens processed using the plurality of parameter sets during a predetermined number of recent iterations, requests the second parameter set from the external device, and stores the second parameter set in the main memory.

10. The neural network system of claim 6, wherein, when the accelerator performs an inference operation,
the control circuit estimates a second parameter set to be used for a next inference operation based on the number of tokens processed using the plurality of parameter sets during a predetermined number of recent inference operations, requests the second parameter set from the external device, and stores the second parameter set in the main memory.
